(19) United States
(12) Patent Application Publication
(10) Pub. No.: US 2022/0189401 A1
(43) Pub. Date: Jun. 16, 2022

(54) PIXEL CIRCUIT, DISPLAY SUBSTRATE, DISPLAY DEVICE AND PIXEL DRIVING METHOD

(71) Applicant: BOE TECHNOLOGY GROUP CO., LTD., Beijing (CN)

(72) Inventors: Tian DONG, Beijing (CN); Libin LIU, Beijing (CN)

(21) Appl. No.: 17/598,999

(22) PCT Filed: Jan. 14, 2021
(86) PCT No.: PCT/CN2021/071752

§ 371 Date: Sep. 28, 2021

(30) Foreign Application Priority Data
Jan. 14, 2020 (CN) 202010036455.4

(51) Int. Cl. G09G 3/3233; G09G 3/3291

(52) U.S. Cl. CPC G09G 3/3233; G09G 2320/0233; G09G 3/3291

(57) ABSTRACT

Embodiments of the present disclosure provide a pixel circuit, a display substrate, a display device and a pixel driving method. In the pixel circuit, a threshold compensation circuit is coupled to a third control signal line, a control electrode of a driving transistor, first and second electrodes of the driving transistor, a first power terminal and a fixed voltage terminal, and is configured to acquire a threshold voltage of the driving transistor, and apply first and second control voltages respectively to the control and second electrodes of the driving transistor in response to the control of a second control signal line and the control of the third control signal line, and a difference between the first control voltage and the second control voltage is related to the threshold voltage of the driving transistor. Thus, the compensation for the threshold voltage and the power supply voltage can be realized.

### TECHNICAL FIELD

The present disclosure relates to the field of display, and in particular, to a pixel circuit, a display substrate, a display device and a pixel driving method.

### BACKGROUND

In an Organic Light-Emitting Diode (OLED) display device, a light emitting device is driven to emit light by a current generated by a driving transistor in a saturated state. Since present manufacturing processes of OLED display devices can hardly ensure the uniformity of threshold voltages of driving transistors, and the threshold voltages of the driving transistors may drift to different extents in use, the problem of uneven luminance of pixels in the OLED display device is caused.

### SUMMARY

The present disclosure provides a pixel circuit, a display substrate, a display device and a pixel driving method to at least partially solve the technical problem in the related art.

In a first aspect of the present disclosure, there is provided a pixel circuit, including: a reference writing circuit, a threshold compensation circuit, a data writing circuit, a light emission control circuit, a driving transistor, and a light emitting device.

The reference writing circuit is coupled to a reference voltage terminal, a first control signal line and a control electrode of the driving transistor and is configured to write a reference voltage supplied by the reference voltage terminal to the control electrode of the driving transistor in response to the control of the first control signal line; the data writing circuit is coupled to a data line, a second control signal line and the control electrode of the driving transistor and is configured to write a data voltage supplied by the data line to the control electrode of the driving transistor in response to the control of the second control signal line; the threshold compensation circuit is coupled to a third control signal line, the control electrode of the driving transistor, a first electrode of the driving transistor, a second electrode of the driving transistor, a first power terminal and a fixed voltage terminal, and is configured to acquire a threshold voltage of the driving transistor, and apply, in response to the control of the second control signal line and the control of the third control signal line, a first control voltage to the control electrode of the driving transistor and a second control voltage to the second electrode of the driving transistor, respectively, and a difference between the first control voltage and the second control voltage is related to the threshold voltage of the driving transistor; the light emission control circuit is coupled to a fifth control signal line and is configured to control connection/disconnection between the second electrode of the driving transistor and a first electrode of the light emitting device in response to the control of the fifth control signal line; and the driving transistor is configured to output a corresponding driving current in response to the control of the first and second control voltages, so as to drive the light emitting device.

In some embodiments, the threshold compensation circuit includes: a third transistor, a first capacitor and a second capacitor; a control electrode of the third transistor is coupled to the third control signal line, a first electrode of the third transistor is coupled to the first power terminal, and a second electrode of the third transistor is coupled to the first electrode of the driving transistor; and a first terminal of the first capacitor is coupled to the control electrode of the driving transistor, a second terminal of the first capacitor and a first terminal of the second capacitor are both coupled to the second electrode of the driving transistor, and a second terminal of the second capacitor is coupled to the fixed voltage terminal.

In some embodiments, the reference writing circuit includes: a first transistor; and a control electrode of the first transistor is coupled to the first control signal line, a first electrode of the first transistor is coupled to the reference voltage terminal, and a second electrode of the first transistor is coupled to the control electrode of the driving transistor.

In some embodiments, the data writing circuit includes: a second transistor; and a control electrode of the second transistor is coupled to the second control signal line, a first electrode of the second transistor is coupled to the data line, and a second electrode of the second transistor is coupled to the control electrode of the driving transistor.

In some embodiments, the difference between the first control voltage and the second control voltage is Vdata−Vref+Vth−k(Vdata−Vref), where Vdata is the data voltage, Vref is the reference voltage, Vth is the threshold voltage of the driving transistor, and k is a coefficient greater than 0 and less than 1.

In some embodiments, the fixed voltage terminal is the first power terminal or the reference voltage terminal.

In some embodiments, the light emission control circuit includes: a fifth transistor; and a control electrode of the fifth transistor is coupled to the fifth control signal line, a first electrode of the fifth transistor is coupled to the second electrode of the driving transistor, and a second electrode of the fifth transistor is coupled to the first electrode of the light emitting device, and a second electrode of the light emitting device is coupled to a second power terminal.

In some embodiments, the pixel circuit further includes a reset circuit; the reset circuit is coupled to a reset voltage terminal, a fourth control signal line and the second electrode of the driving transistor and is configured to write a reset voltage supplied by the reset voltage terminal to the second electrode of the driving transistor in response to the control of the fourth control signal line; or the reset circuit is coupled to a reset voltage terminal, a fourth control signal line and the first electrode of the light emitting device and is configured to write a reset voltage supplied by the reset voltage terminal to the first electrode of the light emitting device in response to the control of the fourth control signal line.

In some embodiments, the reset circuit includes: a fourth transistor; a control electrode of the fourth transistor is coupled to the fourth control signal line, and a first electrode of the fourth transistor is coupled to the reset voltage terminal; in a case where the reset circuit is coupled to the first electrode of the driving transistor, a second electrode of the fourth transistor is coupled to the second electrode of the driving transistor; and in a case where the reset circuit is coupled to the first electrode of the light emitting device, the second electrode of the fourth transistor is coupled to the first electrode of the light emitting device.

In some embodiments, in the case where the reset circuit is coupled to the first electrode of the light emitting device, the fourth control signal line and the first control signal line are the same signal line.

In some embodiments, each of the transistors is an N-type transistor.

In a second aspect of the present disclosure, there is provided a display substrate, including the pixel circuit provided in the first aspect.

In a third aspect of the present disclosure, there is provided a display device, including the display substrate provided in the second aspect.

In a fourth aspect of the present disclosure, there is provided a pixel driving method based on the pixel circuit provided in the first aspect, and the pixel driving method includes: in a threshold acquisition stage, writing the reference voltage to the control electrode of the driving transistor by the reference writing circuit, and acquiring the threshold voltage of the driving transistor and setting a voltage of the second electrode of the driving transistor to Vref−Vth by the threshold compensation circuit; in a data writing stage, writing the data voltage to the control electrode of the driving transistor by the data writing circuit, and setting the voltage of the second electrode of the driving transistor to Vref−Vth+k(Vdata−Vref) by the threshold compensation circuit; and in a light emission stage, writing the first control voltage and the second control voltage to the control electrode of the driving transistor and the second electrode of the driving transistor respectively by the threshold compensation circuit, and outputting a corresponding driving current by the driving transistor in response to the control of the first and second control voltages, so as to drive the light emitting device.

In some embodiments, k=Ca/(Ca+Cb), where Ca is a capacitance value of the first capacitor and Cb is a capacitance value of the second capacitor.

In a case where the pixel circuit includes the reset circuit, the pixel driving method further includes: in a reset preparation stage, writing the reference voltage to the control electrode of the driving transistor by the reference writing circuit, and writing the reset voltage to the second electrode of the driving transistor by the reset circuit.

### BRIEF DESCRIPTION OF THE DRAWINGS

FIG. 1 is a circuit diagram of a pixel circuit according to an embodiment of the present disclosure.

FIG. 2 is a driving timing diagram of the pixel circuit shown in FIG. 1.

FIG. 3 is a circuit diagram of a pixel circuit according to another embodiment of the present disclosure.

FIG. 4 is a driving timing diagram of the pixel circuit shown in FIG. 3.

FIG. 5 is another driving timing diagram of the pixel circuit shown in FIG. 3.

FIG. 6 is a circuit diagram of a pixel circuit according to still another embodiment of the present disclosure.

FIG. 7 is a circuit diagram of a pixel circuit according to yet another embodiment of the present disclosure.

FIG. 8 is a flowchart illustrating a pixel driving method according to an embodiment of the present disclosure.

### DETAILED DESCRIPTION

In order to enable those of ordinary skill in the art to better understand the technical solutions of the present disclosure, the present disclosure is described in detail below with reference to the accompanying drawings and specific embodiments.

A light emitting device in the embodiments of the present disclosure may be a current-driven light emitting device, such as a Light Emitting Diode (LED) or an OLED in the prior art. The embodiments of the present disclosure are described by taking a case where the light emitting device is an OLED as an example.

The light emitting device has a first electrode and a second electrode, one of which is an anode and the other is a cathode. The embodiments of the present disclosure are exemplarily described by taking a case where the first electrode of the light emitting device is an anode and the second electrode of the light emitting device is a cathode.

Transistors in the embodiments of the present disclosure may be thin film transistors or field effect transistors or other switching devices having the same characteristics. In general, a transistor includes three electrodes: a gate, a source and a drain, and the source and the drain in the transistor are symmetrical in structure and are interchangeable as required. In the embodiments of the present disclosure, a control electrode of a transistor refers to a gate of the transistor, and one of a first electrode and a second electrode of the transistor serves as a source and the other one serves as a drain.

In addition, the transistors can be classified into N-type transistors and P-type transistors according to their characteristics. In a case where a transistor is an N-type transistor, a turn-on voltage thereof is a high level voltage, and a turn-off voltage thereof is a low level voltage; and in a case where a transistor is a P-type transistor, a turn-on voltage thereof is a low level voltage, and a turn-off voltage thereof is a high level voltage.

The embodiments below are exemplarily described by taking a case where each transistor is an N-type transistor and an effective voltage of a control electrode of each transistor is a high level voltage as an example. However, type selection of specific transistors does not impose any limitation on the technical solutions of the present disclosure.

With reference to FIGS. 1, 3, 6 and 7, the embodiments of the present disclosure provide a pixel circuit, including a reference writing circuit 1, a threshold compensation circuit 6, a data writing circuit 2, a light emission control circuit 5, a driving transistor DTFT, and a light emitting device OLED.

The reference writing circuit 1 is coupled to a reference voltage terminal PVref, a first control signal line SCAN1 and a control electrode of the driving transistor DTFT and is configured to write a reference voltage supplied by the reference voltage terminal PVref to the control electrode of the driving transistor DTFT in response to the control of the first control signal line SCAN1.

The data writing circuit 2 is coupled to a data line DATA, a second control signal line SCAN2, and the control electrode of the driving transistor DTFT and is configured to write a data voltage supplied by the data line DATA to the control electrode of the driving transistor DTFT in response to the control of the second control signal line SCAN2.

The threshold compensation circuit 6 is coupled to a third control signal line SCAN3, the control electrode of the driving transistor DTFT, a first electrode of the driving transistor DTFT, a second electrode of the driving transistor DTFT, a first power terminal and a fixed voltage terminal, and is configured to acquire a threshold voltage of the driving transistor DTFT, and apply a first control voltage to the control electrode of the driving transistor DTFT and a second control voltage to the second electrode of the driving transistor DTFT in response to the control of the second control signal line SCAN2 and the control of the third control signal line SCAN3, respectively; and a difference between the first control voltage and the second control voltage is related to the threshold voltage of the driving transistor DTFT. For example, the difference between the first control voltage and the second control voltage is Vdata−Vref+Vth−k(Vdata−Vref), where Vdata is the data voltage, Vref is the reference voltage, Vth is the threshold voltage of the driving transistor DTFT, and k is a coefficient greater than 0 and less than 1.

The light emission control circuit 5 is coupled to a fifth control signal line SCAN5 and is configured to control connection/disconnection between the second electrode of the driving transistor DTFT and a first electrode of the light emitting device OLED in response to the control of the fifth control signal line SCAN5.

The driving transistor DTFT is configured to output a corresponding driving current in response to the control of the first and second control voltages, so as to drive the light emitting device OLED.

Since the threshold compensation circuit 6 sets the difference between the first control voltage and the second control voltage to be related to the threshold voltage of the driving transistor, for example, the difference is set to be Vdata−Vref+Vth−k(Vdata−Vref). Under the condition that the difference is maintained, a calculation formula of a driving current I of the driving transistor DTFT when operating in a saturation region is as follows:

I=k′(Vg−Vs−Vth)²=k′[(1−k)(Vdata−Vref)]²

where k′ is a coefficient related to a width-to-length ratio and material selection of the driving transistor DTFT. It can be seen from the above that the driving current of the drive transistor DTFT is independent of the threshold voltage of the drive transistor DTFT and a power supply voltage. Thus, the compensation for the threshold voltage and the compensation for the power supply voltage are both achieved.

An internal structure and an operation principle of the pixel circuit shown in FIG. 1 are described in detail below.

The reference writing circuit 1 includes a first transistor T1; and a control electrode of the first transistor T1 is coupled to the first control signal line SCAN1, a first electrode of the first transistor T1 is coupled to the reference voltage terminal PVref, and a second electrode of the first transistor T1 is coupled to the control electrode of the driving transistor DTFT.

The data writing circuit 2 includes a second transistor T2; and a control electrode of the second transistor T2 is coupled to the second control signal line SCAN2, a first electrode of the second transistor T2 is coupled to the data line DATA, and a second electrode of the second transistor T2 is coupled to the control electrode of the driving transistor DTFT.

The threshold compensation circuit 6 includes a third transistor T3, a first capacitor C1 and a second capacitor C2; a control electrode of the third transistor T3 is coupled to the third control signal line SCAN3, a first electrode of the third transistor T3 is coupled to the first power terminal, and a second electrode of the third transistor T3 is coupled to the first electrode of the driving transistor DTFT; and a first terminal of the first capacitor C1 is coupled to the control electrode of the driving transistor DTFT, a second terminal of the first capacitor C1 and a first terminal of the second capacitor C2 are both coupled to the second electrode of the driving transistor DTFT, and a second terminal of the second capacitor C2 is coupled to the fixed voltage terminal (which may be the first power terminal PVDD or the reference voltage terminal PVref).

The light emission control circuit 5 includes a fifth transistor T5; a control electrode of the fifth transistor T5 is coupled to the fifth control signal line SCAN5, a first electrode of the fifth transistor T5 is coupled to the second electrode of the driving transistor DTFT, and a second electrode of the fifth transistor T5 is coupled to the first electrode of the light emitting device OLED; and a second electrode of the light emitting device OLED is coupled to a second power terminal PVSS.

The pixel circuit shown in FIG. 1 further includes a reset circuit 4 including a fourth transistor T4; and a control electrode of the fourth transistor T4 is coupled to a fourth control signal line SCAN4, a first electrode of the fourth transistor T4 is coupled to a reset voltage terminal PVinit, and a second electrode of the fourth transistor T4 is coupled to the second electrode of the driving transistor DTFT. It should be noted that the reset circuit 4 is an optional circuit module, may be omitted in some embodiments, and does not affect the implementation of functions of the circuit of the present disclosure. The reset circuit 4 can bring the pixel circuit into a uniform state, thereby improving display uniformity.

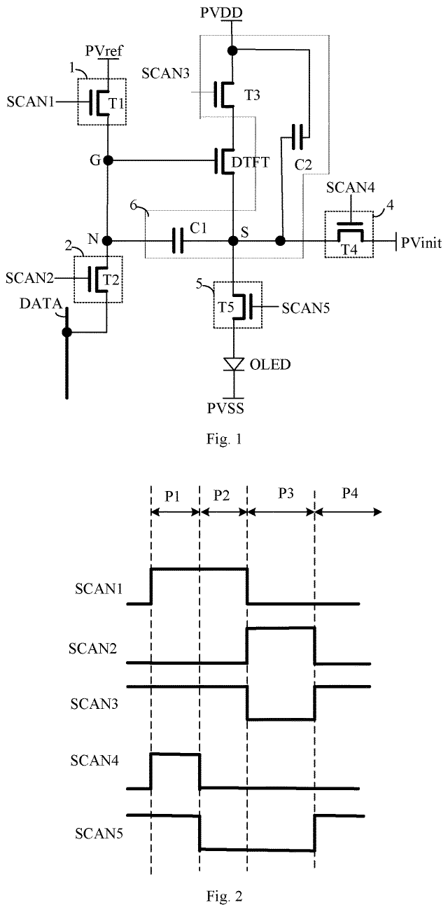

With reference to FIG. 2, the driving timing of the pixel circuit shown in FIG. 1 is as follows.

In a reset preparation stage P1, effective voltages are supplied to the first control signal line SCAN1, the fourth control signal line SCAN4 and the fifth control signal line SCAN5, and an invalid voltage is supplied to the second control signal line SCAN2.

The first transistor T1 and the fourth transistor T4 are turned on, the reference voltage Vref supplied by the reference voltage terminal PVref is written to the control electrode (a node where the control electrode is located is denoted by G) of the driving transistor DTFT through the first transistor T1, and a reset voltage Vinit supplied by the reset voltage terminal PVinit is written to the second electrode (a node where the second electrode is located is denoted by S) of the driving transistor DTFT through the fourth transistor T4.

Whether an effective voltage is supplied to the third control signal line SCAN3 affects nothing in this stage, and thus is not limited.

In a threshold acquisition stage P2, effective voltages are supplied to the first control signal line SCAN1 and the third control signal line SCAN3, and invalid voltages are supplied to the second control signal line SCAN2, the fourth control signal line SCAN4 and the fifth control signal line SCAN5.

The first transistor T1 and the third transistor T3 are in an on state. A voltage at the control electrode of the driving transistor DTFT is maintained to be the reference voltage Vref, and the first power terminal charges the second electrode of the driving transistor DTFT through the third transistor T3 and the driving transistor DTFT until the second electrode (the node S) of the driving transistor DTFT is charged to (Vref−Vth).

In a data writing stage P3, an effective voltage is supplied to the second control signal line SCAN2, and invalid voltages are supplied to the first control signal line SCAN1, the third control signal line SCAN3, the fourth control signal line SCAN4 and the fifth control signal line SCAN5.

The second transistor T2 is in an on state, and a node where the first capacitor C1 is coupled to the second electrode of the driving transistor DTFT is in a floating state. The data line DATA writes the data voltage Vdata to the control electrode of the driving transistor DTFT through the second transistor T2; and a variation of a voltage at the first terminal of the first capacitor C1 is (Vdata−Vref); since the first capacitor C1 and the second capacitor C2 are coupled in series, a variation of a voltage at the second terminal of the first capacitor C1 is (Vdata−Vref)Ca/(Ca+Cb), and the voltage at the second terminal of the first capacitor C1 is Vref−Vth+(Vdata−Vref)Ca/(Ca+Cb), where Ca is a capacitance value of the first capacitor C1 and Cb is a capacitance value of the second capacitor C2. At this time, a voltage difference between the control electrode of the driving transistor DTFT and the second electrode of the driving transistor DTFT (i.e., a voltage difference between the two terminals of the first capacitor C1) is: Vdata−[Vref−Vth+(Vdata−Vref)Ca/(Ca+Cb), and k=Ca/(Ca+Cb).

In a light emission stage P4, effective voltages are supplied to the third control signal line SCAN3 and the fifth control signal line SCAN5, and invalid voltages are supplied to the first control signal line SCAN1, the second control signal line SCAN2 and the fourth control signal line SCAN4.

The third transistor T3 and the fifth transistor T5 are turned on. A current loop is formed from the first power terminal to the second power terminal via the third transistor T3, the driving transistor DTFT, the fifth transistor T5 and the light emitting device OLED. At this time, assuming that the voltage at the second electrode of the driving transistor DTFT is Vs, since the terminal of the first capacitor C1 coupled to the control electrode of the driving transistor DTFT is floating, the voltage difference between the two terminals of the first capacitor C1 is maintained unchanged, and the voltage at the first terminal of the first capacitor C1 (i.e., the voltage at the control electrode of the driving transistor DTFT) is changed to (Vdata−Vref)Cb/(Ca+Cb)+Vs+Vth.

The current I of the driving transistor DTFT satisfies I=k′(Vg−Vs−Vth)²=k′[Cb (Vdata−Vref)/(Ca+Cb)]².

At this time, the current of the driving transistor DTFT is related to none of the threshold voltage of the driving transistor DTFT, the voltage VDD of the first power terminal and a voltage VSS of the second power terminal.

It should be noted that, for ensuring normal operation of the above circuit in a case where the circuit is provided with the reset circuit 4, it is necessary to set the reset voltage Vinit supplied by the reset voltage terminal PVinit to satisfy: Vinit<Vref−Vth<VDD, where VDD is the power supply voltage supplied by the first power terminal. The higher the reference voltage, the larger the lower limit of the data voltage Vdata. A compensation range of the threshold voltage Vth can be adjusted through selection of the reference voltage and the reset voltage.

In particular, since the second electrode of the driving transistor DTFT is directly charged in the threshold acquisition stage P2, a leakage current generated by the fifth transistor T5 is small, and a better threshold compensation effect can be produced.

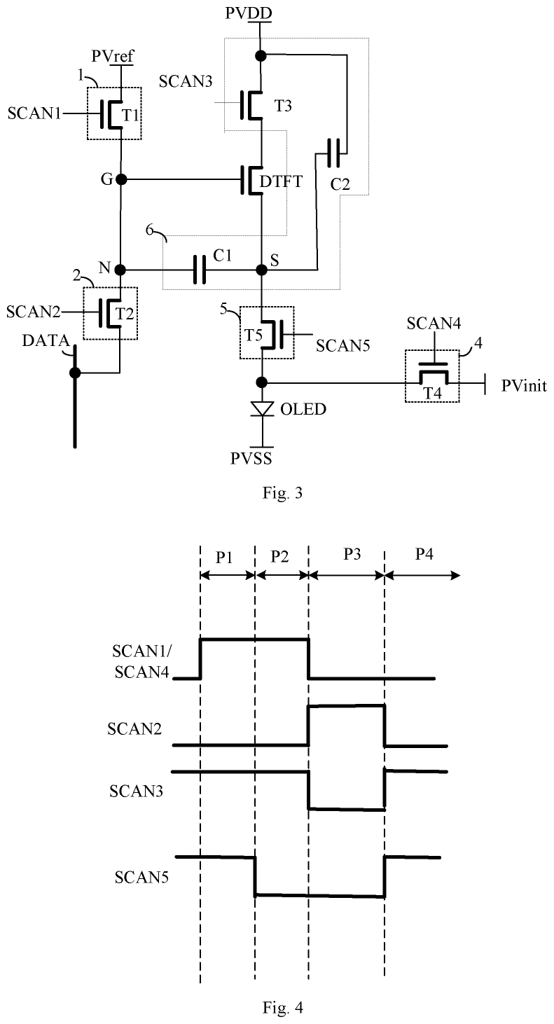

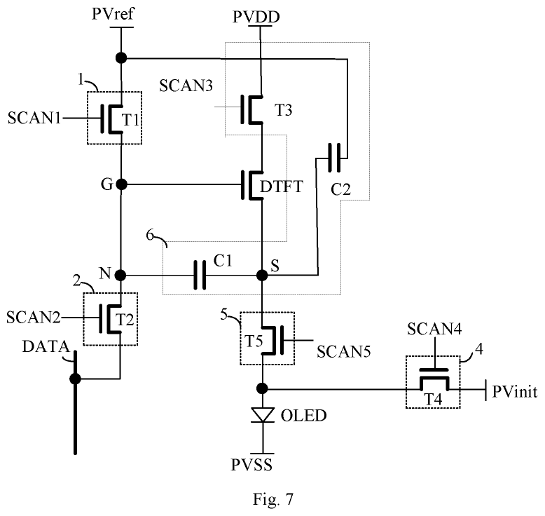

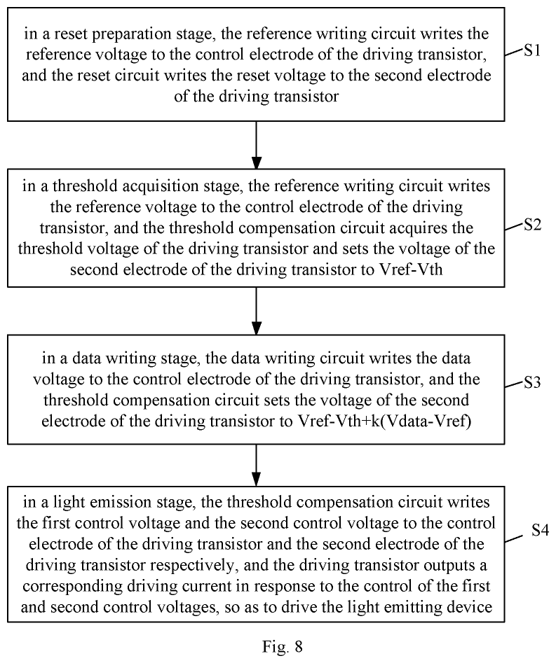

The second electrode of the second capacitor C2 needs to be always kept at a fixed voltage, so the second electrode needs to be coupled to a fixed voltage terminal. With reference to FIGS. 1 and 3, the first power terminal may be selected as the fixed voltage terminal. Alternatively, with reference to FIGS. 7 and 8, the reference voltage terminal PVref may be selected as the fixed voltage terminal.

The second electrode of the fourth transistor T4 is directly coupled to the second electrode of the driving transistor DTFT in the pixel circuit shown in FIG. 1, whereas the second electrode of the fourth transistor T4 is coupled to the first electrode of the light emitting device OLED in the pixel circuit shown in FIG. 3. In other words, the reset circuit 4 can reset the second electrode of the driving transistor DTFT and can also reset the first electrode of the light emitting device OLED.

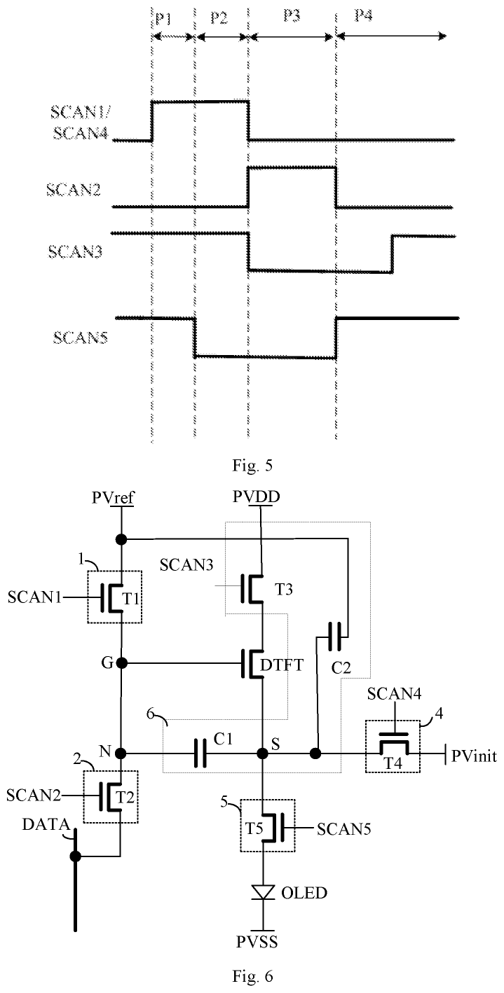

One advantage of the pixel circuit shown in FIG. 3 is that one signal line can be used as both the first control signal line SCAN1 and the fourth control signal line SCAN4 because the timing of the first control signal line SCAN1 corresponding to the first transistor T1 is the same as that of the fourth control signal line SCAN4 corresponding to the fourth transistor T4, as shown in FIG. 4.

With reference to the driving timing shown in FIG. 4, in the reset preparation stage P1, effective voltages are supplied to the first control signal line SCAN1, the fourth control signal line SCAN4 and the fifth control signal line SCAN5, and an invalid voltage is supplied to the second control signal line SCAN2.

The first transistor T1, the fourth transistor T4 and the fifth transistor T5 are turned on. The reference voltage terminal PVref charges the gate of the driving transistor DTFT through the first transistor T1, and the reset voltage terminal PVinit charges the second electrode of the driving transistor DTFT through the fourth transistor T4 and the fifth transistor T5.

Whether an effective voltage is supplied to the third control signal line SCAN3 affects nothing in this stage, and thus is not limited.

In the threshold acquisition stage P2, effective voltages are supplied to the first control signal line SCAN1 and the third control signal line SCAN3, and invalid voltages are supplied to the second control signal line SCAN2 and the fifth control signal line SCAN5.

The first transistor T1 and the third transistor T3 are turned on. With reference to the above description, acquisition of the threshold voltage is performed in this stage.

Whether an effective voltage is supplied to the fourth control signal line SCAN4 affects nothing in this stage, and thus is not limited.

In the data writing stage P3, an effective voltage is supplied to the second control signal line SCAN2, and invalid voltages are supplied to the first control signal line SCAN1, the third control signal line SCAN3, the fourth control signal line SCAN4 and the fifth control signal line SCAN5.

The second transistor T2 is turned on. With reference to the above description, writing of the data voltage and adjustment of the voltage at the second electrode of the driving transistor DTFT are completed in this stage.

In the light emission stage P4, invalid voltages are supplied to the first control signal line SCAN1, the second control signal line SCAN2 and the fourth control signal line SCAN4, and effective voltages are supplied to the third control signal line SCAN3 and the fifth control signal line SCAN5.

The third transistor T3, the driving transistor DTFT, the fifth transistor T5 and the light emitting device OLED are located in a same current path.

Reference can be made to the above description for a calculation formula of a current of the driving transistor DTFT in this stage.

With reference to FIG. 5, another advantage of the pixel circuit shown in FIG. 3 is that the duration of application of the invalid voltage to the third control signal line SCAN3 may be appropriately prolonged; although the prolongation may affect the duration of light emission of the light emitting device OLED in the light emission stage, waveforms of the third control signal line SCAN3 and the fifth control signal line SCAN5 may be controlled to be identical to each other and only have a certain time difference, which makes it feasible to dispose one shift register circuit group to generate the waveforms supplied to the third control signal line SCAN3 and the fifth control signal line SCAN5, thereby reducing the number of gate driving circuits at the periphery of a display substrate and simplifying the circuit design of the display substrate.

Furthermore, with reference to FIG. 5, waveforms of signals supplied to the first control signal line SCAN1 and the second control signal line SCAN2 are identical to each other and only have a certain time difference, which makes it feasible to use one shift register group to supply the signals to the two control signal lines, thereby further reducing the number of the gate driving circuits at the periphery of the display substrate.

The driving timing of the pixel circuit shown in FIG. 6 is the same as that of the pixel circuit shown in FIG. 1. The driving timing of the pixel circuit shown in FIG. 7 is the same as that of the pixel circuit shown in FIG. 3.

In the pixel circuits shown in FIGS. 6 and 7, since the second capacitor C2 is not coupled to the first power terminal, an influence of a voltage drop of the first power terminal on the voltage at the second electrode of the driving transistor DTFT is avoided.

In the pixel circuits shown in FIGS. 3 and 7, the fourth control signal line SCAN4 and the first control signal line SCAN1 may be set as one signal line.

Optionally, each transistor is an N-type transistor. Since the hysteresis effect of the N-type transistors is smaller than that of the P-type transistors, short-term afterimage in display can be improved.

An embodiment of the present disclosure further provides a display substrate, including the above pixel circuit.

The display substrate may include a plurality of gate lines for supplying scanning signals and a plurality of data lines for supplying data signals DATA, and the plurality of gate lines and the plurality of data lines intersect to define a plurality of pixel units, each of which includes the above pixel circuit and is coupled to one of the plurality of gate lines and one of the plurality of data lines.

An embodiment of the present disclosure further provides a display device, including the above display substrate.

The display device is any product or component having a display function, such as an OLED display panel, a quantum dot light emitting diode display panel, a mobile phone, a monitor and a navigator.

With reference to FIG. 8, an embodiment of the present disclosure further provides a pixel driving method based on the above pixel circuit, and the pixel driving method may include the following steps S1 to S4.

At the step S1, in a reset preparation stage P1, the reference writing circuit 1 writes the reference voltage to the control electrode of the driving transistor DTFT, and the reset circuit 4 writes the reset voltage to the second electrode of the driving transistor DTFT.

At the step S2, in a threshold acquisition stage P2, the reference writing circuit 1 writes the reference voltage to the control electrode of the driving transistor DTFT, and the threshold compensation circuit 6 acquires the threshold voltage of the driving transistor DTFT and sets the voltage of the second electrode of the driving transistor DTFT to Vref−Vth.

At the step S3, in a data writing stage P3, the data writing circuit 2 writes the data voltage to the control electrode of the driving transistor DTFT, and the threshold compensation circuit 6 sets the voltage of the second electrode of the driving transistor DTFT to Vref−Vth+k(Vdata−Vref).

At the step S4, in a light emission stage P4, the threshold compensation circuit 6 writes the first control voltage and the second control voltage to the control electrode of the driving transistor DTFT and the second electrode of the driving transistor DTFT respectively, and the driving transistor DTFT outputs a corresponding driving current in response to the control of the first and second control voltages, so as to drive the light emitting device OLED.

Reference may be made to FIGS. 2, 4 and 5 and the corresponding description for detailed driving timing. For example, for the driving timing of the pixel circuit shown in FIG. 1, reference may be made to the driving timing shown in FIG. 2, and thus the driving timing is not described in detail here.

It should be noted that the step S1 is optional; and in a case where the pixel circuit includes the reset circuit 4, the pixel driving method provided by the embodiment of the present disclosure includes the step S1.

Furthermore, for the pixel circuits shown in FIGS. 1, 3, 6 and 7, k=Ca/(Ca+Cb), where Ca is the capacitance value of the first capacitor C1 and Cb is the capacitance value of the second capacitor C2.

The technical solutions of the present disclosure can realize the compensation for the threshold voltage of the driving transistor DTFT to free the driving current from an influence of the threshold voltage of the driving transistor DTFT, thereby eliminating the problem of uneven luminance of the pixels caused by the non-uniformity or drifting of the threshold voltages. Meanwhile, the technical solutions of the present disclosure can also realize the compensation for the operating voltage to free the driving current from an influence of the operating voltage, thereby eliminating the problem of uneven overall display brightness caused by a voltage drop of the operating voltage.

In addition, since the driving current output by the driving transistor DTFT in the light emission stage is related to the reference voltage, the luminance of the light emitting device OLED can be controlled by adjusting the reference voltage. Therefore, the overall display brightness of the display device can be adjusted by adjusting the reference voltage.

It should be understood that the above embodiments are merely exemplary embodiments adopted to illustrate the principles of the present disclosure, but the present disclosure is not limited thereto. Those of ordinary skill in the art can make various modifications and improvements without departing from the spirit and essence of the present disclosure, and those modifications and improvements should be also considered to fall within the scope of the present disclosure.

1. A pixel circuit, comprising: a reference writing circuit, a threshold compensation circuit, a data writing circuit, a light emission control circuit, a driving transistor, and a light emitting device; wherein
the reference writing circuit is coupled to a reference voltage terminal, a first control signal line and a control electrode of the driving transistor and is configured to write a reference voltage supplied by the reference voltage terminal to the control electrode of the driving transistor in response to the control of the first control signal line;
the data writing circuit is coupled to a data line, a second control signal line and the control electrode of the driving transistor and is configured to write a data voltage supplied by the data line to the control electrode of the driving transistor in response to the control of the second control signal line;
the threshold compensation circuit is coupled to a third control signal line, the control electrode of the driving transistor, a first electrode of the driving transistor, a second electrode of the driving transistor, a first power terminal and a fixed voltage terminal, and is configured to acquire a threshold voltage of the driving transistor, and apply, in response to the control of the second control signal line and the control of the third control signal line, a first control voltage to the control electrode of the driving transistor and a second control voltage to the second electrode of the driving transistor, respectively, and a difference between the first control voltage and the second control voltage is related to the threshold voltage of the driving transistor;
the light emission control circuit is coupled to a fifth control signal line and is configured to control connection/disconnection between the second electrode of the driving transistor and a first electrode of the light emitting device in response to the control of the fifth control signal line; and
the driving transistor is configured to output a corresponding driving current in response to the control of the first control voltage and the second control voltage, so as to drive the light emitting device.

2. The pixel circuit of claim 1, wherein the threshold compensation circuit comprises: a third transistor, a first capacitor and a second capacitor;
a control electrode of the third transistor is coupled to the third control signal line, a first electrode of the third transistor is coupled to the first power terminal, and a second electrode of the third transistor is coupled to the first electrode of the driving transistor; and
a first terminal of the first capacitor is coupled to the control electrode of the driving transistor, a second terminal of the first capacitor and a first terminal of the second capacitor are both coupled to the second electrode of the driving transistor, and a second terminal of the second capacitor is coupled to the fixed voltage terminal.

3. The pixel circuit of claim 1, wherein the reference writing circuit comprises: a first transistor; and a control electrode of the first transistor is coupled to the first control signal line, a first electrode of the first transistor is coupled to the reference voltage terminal, and a second electrode of the first transistor is coupled to the control electrode of the driving transistor.

4. The pixel circuit of claim 1, wherein the data writing circuit comprises: a second transistor; and a control electrode of the second transistor is coupled to the second control signal line, a first electrode of the second transistor is coupled to the data line, and a second electrode of the second transistor is coupled to the control electrode of the driving transistor.

5. The pixel circuit of claim 1, wherein the difference between the first control voltage and the second control voltage is Vdata−Vref+Vth−k(Vdata−Vref), where Vdata is the data voltage, Vref is the reference voltage, Vth is the threshold voltage of the driving transistor, and k is a coefficient greater than 0 and less than 1.

6. The pixel circuit of claim 1, wherein the fixed voltage terminal is the first power terminal or the reference voltage terminal.

7. The pixel circuit of claim 1, wherein the light emission control circuit comprises: a fifth transistor; and a control electrode of the fifth transistor is coupled to the fifth control signal line, a first electrode of the fifth transistor is coupled to the second electrode of the driving transistor, and a second electrode of the fifth transistor is coupled to the first electrode of the light emitting device, and a second electrode of the light emitting device is coupled to a second power terminal.

8. The pixel circuit of claim 1, further comprising a reset circuit;
wherein the reset circuit is coupled to a reset voltage terminal, a fourth control signal line and the second electrode of the driving transistor and is configured to write a reset voltage supplied by the reset voltage terminal to the second electrode of the driving transistor in response to the control of the fourth control signal line.

9. The pixel circuit of claim 1, further comprising a reset circuit;
wherein the reset circuit is coupled to a reset voltage terminal, a fourth control signal line and the first electrode of the light emitting device and is configured to write a reset voltage supplied by the reset voltage terminal to the first electrode of the light emitting device in response to the control of the fourth control signal line.

10. The pixel circuit of claim 8, wherein the reset circuit comprises: a fourth transistor; and a control electrode of the fourth transistor is coupled to the fourth control signal line, and a first electrode of the fourth transistor is coupled to the reset voltage terminal, and a second electrode of the fourth transistor is coupled to the second electrode of the driving transistor.

11. The pixel circuit of claim 9, wherein the reset circuit comprises: a fourth transistor; and a control electrode of the fourth transistor is coupled to the fourth control signal line, and a first electrode of the fourth transistor is coupled to the reset voltage terminal, and a second electrode of the fourth transistor is coupled to the first electrode of the light emitting device.

12. The pixel circuit of claim 11, wherein the fourth control signal line and the first control signal line are one signal line.

13. The pixel circuit of claim 19, wherein each transistor is an N-type transistor.

14. A display substrate, comprising: a pixel circuit of claim 1.

15. A display device, comprising: a display substrate of claim 14.

16. A pixel driving method based on the pixel circuit of claim 1, comprising:
in a threshold acquisition stage, writing the reference voltage to the control electrode of the driving transistor by the reference writing circuit, and acquiring the threshold voltage of the driving transistor and setting a voltage of the second electrode of the driving transistor to Vref−Vth by the threshold compensation circuit;
in a data writing stage, writing the data voltage to the control electrode of the driving transistor by the data writing circuit, and setting the voltage of the second electrode of the driving transistor to Vref−Vth+k(Vdata−Vref) by the threshold compensation circuit; and
in a light emission stage, writing the first control voltage and the second control voltage to the control electrode of the driving transistor and the second electrode of the driving transistor respectively by the threshold compensation circuit, and outputting a corresponding driving current by the driving transistor in response to the control of the first and second control voltages, so as to drive the light emitting device.

17. The pixel driving method of claim 16, wherein
the threshold compensation circuit comprises: a third transistor, a first capacitor and a second capacitor;
a control electrode of the third transistor is coupled to the third control signal line, a first electrode of the third transistor is coupled to the first power terminal, and a second electrode of the third transistor is coupled to the first electrode of the driving transistor; and
a first terminal of the first capacitor is coupled to the control electrode of the driving transistor, a second terminal of the first capacitor and a first terminal of the second capacitor are both coupled to the second electrode of the driving transistor, and a second terminal of the second capacitor is coupled to the fixed voltage terminal;
the reference writing circuit comprises: a first transistor, and a control electrode of the first transistor is coupled to the first control signal line, a first electrode of the first transistor is coupled to the reference voltage terminal, and a second electrode of the first transistor is coupled to the control electrode of the driving transistor;
the data writing circuit comprises: a second transistor; and a control electrode of the second transistor is coupled to the second control signal line, a first electrode of the second transistor is coupled to the data line, and a second electrode of the second transistor is coupled to the control electrode of the driving transistor, and
k=Ca/(Ca+Cb),
where Ca is a capacitance value of the first capacitor and Cb is a capacitance value of the second capacitor.

18. The pixel driving method of claim 16, wherein the pixel circuit further comprises a reset circuit coupled to a reset voltage terminal, a fourth control signal line, and one of the second electrode of the driving transistor and the first electrode of the light emitting device and configured to write a reset voltage supplied by the reset voltage terminal to one of the second electrode of the driving transistor and the first electrode of the light emitting device in response to the control of the fourth control signal line, the pixel driving method further comprises:
in a reset preparation stage, writing the reference voltage to the control electrode of the driving transistor by the reference writing circuit, and writing the reset voltage to the second electrode of the driving transistor by the reset circuit.

19. The pixel circuit of claim 2, wherein
the reference writing circuit comprises: a first transistor; and a control electrode of the first transistor is coupled to the first control signal line, a first electrode of the first transistor is coupled to the reference voltage terminal, and a second electrode of the first transistor is coupled to the control electrode of the driving transistor;
the data writing circuit comprises: a second transistor; and a control electrode of the second transistor is coupled to the second control signal line, a first electrode of the second transistor is coupled to the data line, and a second electrode of the second transistor is coupled to the control electrode of the driving transistor;
the light emission control circuit comprises: a fifth transistor; and a control electrode of the fifth transistor is coupled to the fifth control signal line, a first electrode of the fifth transistor is coupled to the second electrode of the driving transistor, and a second electrode of the fifth transistor is coupled to the first electrode of the light emitting device, and a second electrode of the light emitting device is coupled to a second power terminal;
the pixel circuit further comprises a reset circuit coupled to a reset voltage terminal, a fourth control signal line, and one of the second electrode of the driving transistor and the first electrode of the light emitting device and configured to write a reset voltage supplied by the reset voltage terminal to the one of the second electrode of the driving transistor and the first electrode of the light emitting device in response to the control of the fourth control signal line; and
the reset circuit comprises: a fourth transistor; and a control electrode of the fourth transistor is coupled to the fourth control signal line, and a first electrode of the fourth transistor is coupled to the reset voltage terminal, and a second electrode of the fourth transistor is coupled to the one of the second electrode of the driving transistor and the first electrode of the light emitting device.

20. The pixel driving method of claim 17, wherein the pixel circuit further comprises a reset circuit coupled to a reset voltage terminal, a fourth control signal line, and one of the second electrode of the driving transistor and the first electrode of the light emitting device and configured to write a reset voltage supplied by the reset voltage terminal to one of the second electrode of the driving transistor and the first electrode of the light emitting device in response to the control of the fourth control signal line, the pixel driving method further comprises:
in a reset preparation stage, writing the reference voltage to the control electrode of the driving transistor by the reference writing circuit, and writing the reset voltage to the second electrode of the driving transistor by the reset circuit.
